(19) United States
(12) Patent Application Publication
(10) Pub. No.: US 2023/0402224 A1
(43) Pub. Date: Dec. 14, 2023

(54) Electrical Device

(71) Applicants: ABB Schweiz AG, Baden (CH); ABB E-mobility B.V., Delft (NL)

(72) Inventors: Jedrzej Banaszczyk, Wieliczka (PL); Michal Rzepecki, Kraków (PL); Amin Bahmani, Erlinsbach (CH); Filip Grecki, Rutihof (CH); Uwe Drofenik, Zürich (CH)

(73) Assignees: ABB Schweiz AG, Baden (CH); ABB E-mobility B.V., Delft (NL)

(21) Appl. No.: 18/331,288

(22) Filed: Jun. 8, 2023

(30) Foreign Application Priority Data
Jun. 9, 2022 (EP) 22178097.6

(51) Int. Cl. H01F 27/32; H01F 27/08; H01F 27/28

(52) U.S. Cl. CPC H01F 27/325; H01F 27/085; H01F 27/2876

(57) ABSTRACT

An electrical device includes a magnetic core, a bobbin extending about and partially covering the magnetic core, wherein the bobbin is made of a thermally conductive dielectric material, wherein the bobbin further comprises an outer body connectable to an inner body, wherein the inner body comprises at least a first contact element being formed as a rib that is configured to directly contact a surface of the magnetic core.

### CROSS-REFERENCE TO RELATED APPLICATIONS

The instant application claims priority to European Patent Application No. 22178097.6, filed on Jun. 9, 2022, which is incorporated herein in its entirety by reference.

### FIELD OF THE DISCLOSURE

The present disclosure generally relates to an electrical device and a method for producing an electrical device.

### BACKGROUND OF THE INVENTION

In an electrical device such as a transformer, for example, in a high-power medium frequency transformer (MFT), the power density has often a high value, because such a transformer is often mounted inside a relatively small compartment and thus, the transformer is surrounded by various other heat sources. This can have a strong impact on the thermal performance of such a transformer arrangement.

To prevent the transformer from overheating in such a thermal environment, usually high-powered fans and highly thermally conductive casting materials are required. However, these technical solutions may lead to high production costs of such a technical arrangement and inappropriate technical efforts may be necessary to obtain or to guarantee a required operating performance of such an electrical device.

### BRIEF SUMMARY OF THE INVENTION

In an embodiment, the present disclosure describes a concept to improve the performance of an electrical device in an efficient way. In a first aspect of the present disclosure, there is provided an electrical device. The electrical device comprises: a magnetic core, a bobbin extending about and partially covering the magnetic core, wherein the bobbin is made of a thermally conductive dielectric material, wherein the bobbin further comprises an outer body connectable to an inner body, wherein the inner body comprises at least a first contact element being formed as a rib that is configured to directly contact a surface of the magnetic core.

In other words, the present disclosure describes that the bobbin, which is made of a highly thermally conductive dielectric material, in the electrical device directly contacts a surface of the magnetic core of the electrical device by a first contact element that is configured as a rib. In this way, the first contact element is configured as a conducting element that conducts or transfers away heat produced by the magnetic core to a space or a cooling channel that is arranged between the magnetic core and an internal wall of the bobbin. The internal wall is part of the outer body of the bobbin. From the space or the cooling channel the transferred heat can be easily evacuated by means of using a suitable cooling technique using a cooling medium, such as an air, a gas or a liquid, that is provided or arranged within said space or cooling channel. An example for such a cooling technique could be forced (air) cooling to effectively evacuate the transferred heat from said cooling channel or space inside the bobbin.

It should be noted in this context that said space that is arranged or provided between the magnetic core and an internal wall of the bobbin may be configured as a cooling channel and thus, both terms space and cooling channel may be used in a similar way. In this way, the performance including the thermal performance of the electrical device is improved as the cooling of the electrical device is optimized in an efficient way. Further, the thermal impact of the electrical device on other surrounding electrical devices is reduced. Thus, a low operating temperature of the electrical device can be achieved. This results in a reduced thermal aging, a better reliability and a longer lifetime of the electrical device.

Further, with this technical solution described by the present disclosure, no additional and external technical cooling means are needed or at least smaller cooling means such as fans can be used to transfer away the heat from the heat source—the magnetic core—of the electrical device in an efficient manner. This allows to build an electrical device with smaller dimensions in a space-saving manner resulting in a reduced weight and in a denser packing in a cabinet. A further advantage of the present disclosure is that a required operating performance and a thermal performance as well of the electrical device can be flexibly and in an effective way adapted to a changing field of application of the electrical device.

### BRIEF DESCRIPTION OF THE SEVERAL VIEWS OF THE DRAWINGS

FIG. 1 shows a first example of a bobbin with a first contact element and a magnetic core of an electrical device of the present disclosure.

FIG. 2 shows a second example of a bobbin with a first contact element, a second contact element and a magnetic core of an electrical device of the present disclosure.

FIG. 3 shows an electrical device with a bobbin of the first example with a magnetic core and a winding wrapped around the bobbin.

FIG. 4 shows an example of a transformer with a bobbin of the present disclosure without a magnetic core.

FIG. 5 shows a schematic flow-diagram of a method of producing an electrical device of the present disclosure.

### DETAILED DESCRIPTION OF THE INVENTION

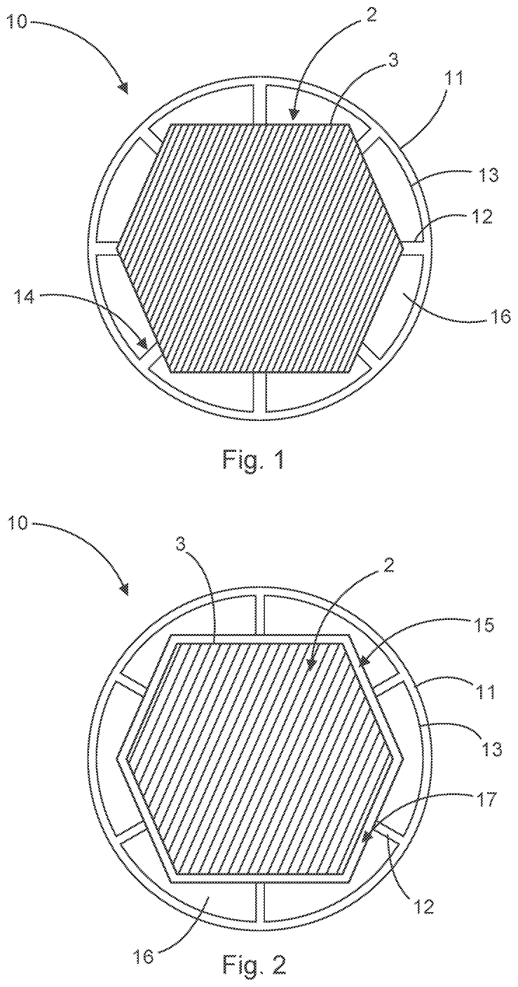

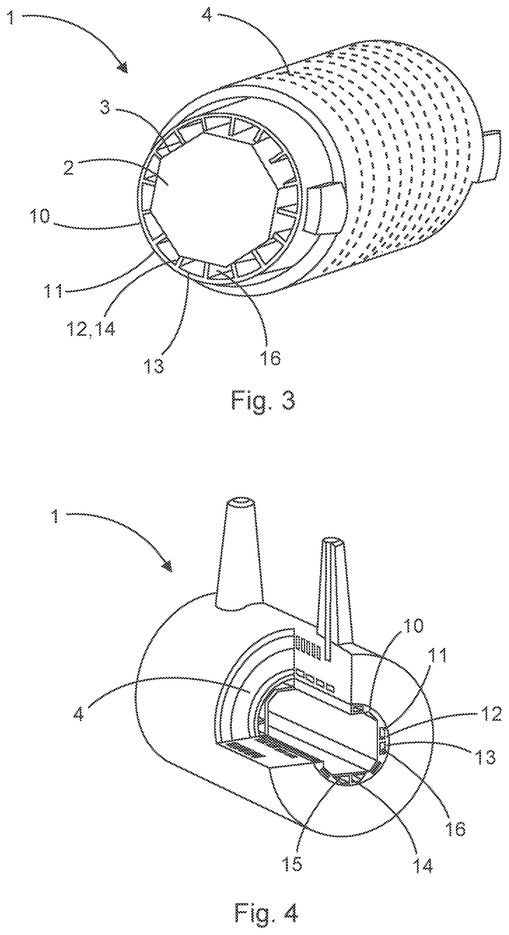

FIG. 1 shows a cross-section of a first example of a bobbin 10 with a first contact element 14 and a magnetic core 2 for an electrical device 1 (not displayed). The bobbin 10 extends about and partially covers the magnetic core 2 (see also in detail in FIG. 3). The bobbin 10 is made of or formed by a thermally conductive dielectric material. The thermally conductive dielectric material of the bobbin 10 and its entire structural elements such as the first contact element in form of or configured as a rib and the second contact element can be made of a thermoplastic material, an epoxy resin with a filler, a ceramic or a carbon material or any other suitable material having properties that allow an effective heat dissipation away from the magnetic core 2, which is one of the main heat sources in this embodiment.

The bobbin 10 comprises an outer body 11 that is connected to an inner body 12. The outer body 11 of the bobbin 10 has a circular or cylindric shape according to the embodiment of FIG. 1. However, the shape of the outer bobbin 10 may vary depending on the field of application of the electrical device 1 or it may depend on shape of the magnetic core 2. It should be mentioned that the shape of the bobbin can be of any other suitable polygonal shape. The inner body 12 comprises a plurality of first contact elements 14. Each of the contact elements 14 is formed or configured as a rib. In FIG. 1, a plurality of ribs 14 directly contact a surface 3 of the magnetic core 2. This ensures that heat generated by the magnetic core 2 is directly transported to the outer body 11 of the bobbin 10.

The size of the ribs 14 meaning the wall thickness of the ribs may vary depending on the targeted field of application of the electrical device 1. For example, for high power transformers using relatively large bobbins, an approximate wall thickness of a rib 14 may lay in a range between 10 and 20 mm. When using thermoplastic injection molding for producing the bobbin 10, a wall thickness of a rib 14 can be in a range between 0.5 to 4 mm. However, in the case of a silica filled epoxy casting, the wall thickness of a rib 14 could be higher than 10 mm.

In the present invention, the ribs 14 as shown in each of the embodiments of FIGS. 1 to 4 have equal dimensions. However, this is only an example. Depending on the field of application, individual or single or several ribs 14 of the bobbin 10 may be formed or shaped individually compared to other ribs. To optimize the contact surface of a rib 14 in view of the surface 3 of the magnetic core 2, the shape or the dimensions of a rib 14 may be adapted accordingly.

To be more specific, the heat produced by the magnetic core 2 is transferred to a space 16 forming a cooling channel. The cooling channel 16 is a clearance or a space limited by an inner wall 13 of the outer body 11 of the bobbin 10 and a surface 3 of the magnetic core 2 of the bobbin 10. The cooling channel 16 receives or absorbs the heat generated by the magnetic core 2, the body of the device or the windings. In the present invention, the plurality of cooling channels 16 are identical in shape and dimensions facilitating the producing the bobbin 10. However, different shapes or dimensions of individual ribs 14 of the plurality of ribs may be possible, if useful when optimizing a (thermal) performance of the electrical device 1.

In the embodiment of FIG. 1, the bobbin 10 comprises a plurality of cooling channels 16 from which the heat transferred from the magnetic core 2 can be easily evacuated in different ways as described in the following.

This evacuation may be enabled by using a cooling medium that may be temporarily arranged or located inside of a cooling channel 16. The cooling medium may be a cooling fluid, such as a cooling gas or a cooling liquid. As a preferred example, the cooling fluid can be air that is transported or that flows through said cooling channel 16. This may be provided by using means of an active cooling system, for example, a forced-air cooling device (not displayed in FIG. 1). However, also passive air cooling may be usable for making the cooling air flow through the cooling channel 16 to evacuate the heat located or collected in said cooling channel 16.

FIG. 2 shows the cross-section of a second example of a bobbin 10 with a first contact element 14 and a second contact element 15 and a magnetic core 2 for an electrical device 1. The major difference of the bobbin of FIG. 2 compared to the embodiment of the bobbin of FIG. 1 is that the ribs 14 meaning the plurality of the first contact elements 14 of the bobbin 10 are now connected to a thermally conductive dielectric second contact element 15.

The second contact element 15 surrounds the surface 3 of the magnetic core 2 completely in the embodiment shown in FIG. 2. The term of surrounding the surface 3 in this context of the present invention may mean that the second contact element 15 directly contacts the surface 3 of the magnetic core 2 to achieve an improved or an optimal heat transmission from the magnetic core 2 as a primary heat source of the electrical device 1. In this way, the contact surface between the plurality of ribs 14 and the magnetic core 2 is maximized in a simple manner.

Further, in the embodiment of FIG. 2, the second contact element 15 is formed or configured as a so-called brace around the magnetic core 2. Hence, to be more general, the bobbin 10 may be shaped or formed in such a way as to form a brace around the magnetic core 2. Of course, it is also possible that only a part of the surface 3 of the magnetic core 2 is covered or enclosed for enabling a direct thermal contact by the second contact element or brace 15.

A further way to maximize the heat transfer from the magnetic core 2 to the bobbin 10 can be achieved when the contact surface between the second contact element 15 and the surface 3 of the magnetic core 2 is coated with a conducting material 17 such as a thermally conductive paste.

FIG. 3 shows an electrical device 1 with a bobbin 10 with a magnetic core 2 in an octagonal shape and an electrical conductor 4 configured as a winding. The winding 4 is wrapped around a surface of the bobbin 10 at least partially. Apart from that, the structural elements and dimensions of the bobbin 10 as shown in FIG. 3 are identical with the embodiment of the bobbin 10 as shown in FIG. 1. In this way, the electrical device 1 may be configured as a transformer.

Further referring to FIG. 3, the shape of the bobbin 10 is circular or cylindric. However, other suitable shapes of the bobbin such as a square, octagonal, hexagonal or any other form might be possible. The shape of the bobbin 10 may be adapted to the shape of the magnetic core 2 to maximize the heat transfer from the magnetic core 2 to the bobbin 10.

FIG. 4 shows an example in form of a schematic model of a transformer with a bobbin 10 of the present invention without a magnetic core 2. The transformer may be a high-power medium frequency transformer. However, the present invention may be also applied to any other type of transformer, such as a low-voltage transformer, and is not restricted to a certain type of transformer nor to a certain operating frequency of the transformer. The structural elements and dimensions of the bobbin 10 in FIG. 4 are similar to the embodiment of the bobbin of FIG. 2.

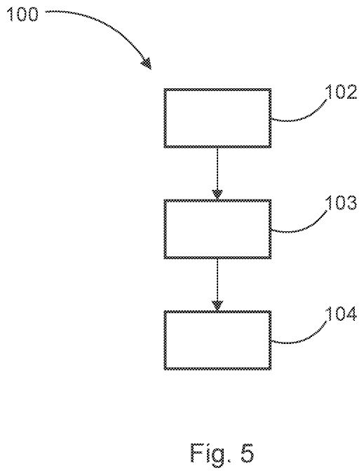

FIG. 5 shows a schematic flow-diagram of a method 100 of producing an electrical device 1 of the present disclosure. In a first step 102, a bobbin 10 is formed from a thermally conductive material. This step of forming the bobbin 10 may be conducted by using different production processes such as thermoplastic extrusion, casting, sintering, 3D printing or injection molding. The choice of a certain production process may depend on requirements in terms thermal performance of the electrical device 1 in which the bobbin 10 is included or on the field of application for the electrical device 1.

In this context, it should be noted that in order to make the formation or production of the bobbin 10 easy, it may be preferred to produce the bobbin by means of thermoplastic extrusion. For this, plastic material with a high thermal conductivity, reaching as high as 3 W/mK and above are commercially available, for example, CoolPoly TCP. Other materials, such as epoxy resin with a thermally conductive filler or ceramics are also possible, but formation of the bobbin 10 may in such a case be more challenging and expensive.

In a second step 103, a magnetic core 2 within the bobbin 10 is provided. In an optional third step 104, an electrical conductor 4 is winded around the bobbin 10. It should be noted that the second step 103 and the third step 104 can be reversed, if suitable for the production of the electrical device 1.

According to an example, an inner wall of the outer body of the bobbin and the surface of the magnetic core forms a space which is configured as a cooling channel. The advantage achieved is that the transferred heat from the magnetic core can be effectively evacuated.

According to an example, the electrical device further comprises a cooling medium arranged inside the cooling channel. The advantage achieved is that depending on the application of the electrical device, any suitable cooling medium may be used to evacuate the transferred heat in an effective way. Smaller fans can be used to transfer the heat away from the magnetic core in an effective way. In this way, the thermal performance of the electrical device can be easily adapted to varying performance requirements of the electrical device.

According to an example, the cooling medium is a cooling fluid. The advantage achieved is that the usage or choice of a cooling fluid may be easily adopted to the field of application of the electrical device.

According to an example, the thermally conductive dielectric material of the bobbin is at least one of a thermoplastic material such as CoolPoly TCP, an epoxy resin with a filler, a ceramic or a carbon material. The advantage achieved is that the choice of the material of the bobbin may be easily adopted to the field of application of the electrical device to achieve a required (thermal) performance of the electrical device.

According to an example, the bobbin is at least one of a circular, square, octagonal hexagonal or any other polygonal shape. The advantage achieved is that the shape or form of the bobbin may be easily adapted to the technical requirements that are essential in a certain field of application.

According to an example, at least first contact element of the bobbin is connectable to a thermally conductive second contact element that surrounds at least partially the surface of the magnetic core. The advantage achieved is that the direct contact surface between the at least first contact element configured as a rib and the magnetic core can be easily maximized.

According to an example, a conducting material is arranged at least partially between the second contact element and the surface of the magnetic core. The advantage achieved is that a heat transfer from the magnetic core to the bobbin can be maximized in a simple manner.

According to a further example, the electrical device comprises an electrical conductor forming a winding that encloses the bobbin. The advantage achieved is that the performance of the electrical device having such a bobbin of the present invention can be improved.

In a second aspect of the present invention, a transformer is provided, wherein the transformer comprises an electrical device of the present invention. The transformer may be a high-power medium frequency transformer.

In a third aspect of the present invention, a method of producing an electrical device is provided with the following steps: In a first step of the method, a bobbin is formed from a thermally conductive material. In a second step of the method, a magnetic core within the bobbin is provided. In an optional third step of the method, an electrical conductor is winded around the bobbin. It should be noted that the second step and the third step can be reversed, if suitable for the production of the electrical device.

In an example of the method, the method step of forming the bobbin comprises at least one of the following production processes: thermoplastic extrusion, casting, sintering, 3D printing or injection molding. The advantage achieved is that the bobbin can be formed in different ways applicable to a required (thermal) performance of said electrical device.

### LIST OF REFERENCE SIGNS

1 Electrical device
2 Magnetic core
3 Surface of the magnetic core
4 Electrical conductor
10 Bobbin
11 Outer body of the bobbin
12 Inner body of the bobbin
13 Inner wall of the bobbin
14 First contact element
15 Second contact element
16 Space/Cooling channel
17 Conducting material
100 Method
102 forming a bobbin
103 providing a magnetic core
104 winding an electrical conductor

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electrical device, comprising:
a magnetic core;
a bobbin extending about and partially covering the magnetic core;
wherein the bobbin is made of a thermally conductive dielectric material;
wherein the bobbin further comprises an outer body connectable to an inner body;
wherein the inner body comprises at least a first contact element being formed as a rib that is configured to directly contact a surface of the magnetic core.

2. The electrical device according to claim 1, wherein an inner wall of the outer body of the bobbin and the surface of the magnetic core form a space which is configured as a cooling channel.

3. The electrical device according to claim 2, further comprising a cooling medium arranged inside the cooling channel.

4. The electrical device according to claim 3, wherein the cooling medium is a cooling fluid.

5. The electrical device according to claim 1, wherein the thermally conductive dielectric material of the bobbin is at least one of a thermoplastic material, an epoxy resin with a filler, a ceramic or a carbon material.

6. The electrical device according to claim 1, wherein the bobbin is at least one of a circular, square, octagonal, hexagonal or any other polygonal shape.

7. The electrical device according to claim 1, wherein the at least first contact element of the bobbin is connectable to a thermally conductive second contact element that surrounds at least partially the surface of the magnetic core.

8. The electrical device according to claim 7, wherein a conducting material is arranged at least partially between the second contact element and the surface of the magnetic core.

9. The electrical device according to claim 1, wherein the electrical device comprises an electrical conductor forming a winding that encloses the bobbin.

10. A transformer, comprising:
an electrical device comprising:
a magnetic core;
a bobbin extending about and partially covering the magnetic core;
wherein the bobbin is made of a thermally conductive dielectric material;
wherein the bobbin further comprises an outer body connectable to an inner body;
wherein the inner body comprises at least a first contact element being formed as a rib that is configured to directly contact a surface (3) of the magnetic core;
wherein the transformer is a high-power medium frequency transformer.

11. A method of producing an electrical device, the electrical device comprising a magnetic core, a bobbin extending about and partially covering the magnetic core, wherein the bobbin is made of a thermally conductive dielectric material, wherein the bobbin further comprises an outer body connectable to an inner body, wherein the inner body comprises at least a first contact element being formed as a rib that is configured to directly contact a surface of the magnetic core, and wherein the transformer is a high-power medium frequency transformer, wherein the method includes:
forming a bobbin from a thermally conductive material;
providing a magnetic core within the bobbin.

12. The method according to claim 11, wherein the step of forming the bobbin comprises at least one of the following production processes: thermoplastic extrusion, casting, sintering, 3D printing or injection molding.

13. The method according to claim 11, further comprising the step of winding an electrical conductor around the bobbin.
